(19) United States
(12) Patent Application Publication
(10) Pub. No.: US 2016/0175881 A1
(43) Pub. Date: Jun. 23, 2016

(54) ELECTROSPRAY METHODS, ELECTROSPRAY SYSTEMS, AND METHODS OF FORMING CRYSTALLINE PARTICLES

(71) Applicant: Nanocopoeia, LLC, Saint Paul, MN (US)

(72) Inventors: James E. Lasch, Oakdale, MN (US); Huijing Fu, Arden Hills, MN (US); Andrew J. Goode, Roseville, MN (US); Joseph Wyman, South Saint Paul, MN (US); Mourad F. Rahi, Maple Grove, MN (US); Doua Thao, St. Paul, MN (US); Mihnea Popa, Inver Grove Heights, MN (US)

(21) Appl. No.: 14/967,187

(22) Filed: Dec. 11, 2015

Related U.S. Application Data
(60) Provisional application No. 62/095,346, filed on Dec. 22, 2014.

(51) Int. Cl. B05D 1/06

(52) U.S. Cl. CPC B05D 1/06

(57) ABSTRACT

Methods of electrospraying particles are disclosed that include electrospraying a liquid spray composition from the nozzle, the liquid spray composition including a liquid and a compound that exhibits a melting point and a crystallization temperature, and at least one of exposing particles formed from the liquid spray composition to a temperature modified environment, exposing particles formed from the liquid spray composition to an organic solvent, and collecting particles formed from the liquid spray composition on at least one of a temperature modified collector, a liquid collector, a variable topography collector, and a dry ice collector.

### CROSS REFERENCE TO RELATED APPLICATIONS

This application claims the benefit of U.S. Provisional Application No. 62/095,346, filed Dec. 22, 2014, which is incorporated herein.

### BACKGROUND

The invention is directed to electrospraying particles.

Electrospraying is a process in which a liquid jet forms and breaks up under influence of electrical forces. During electrospraying a liquid is pumped through a nozzle while an electric field is applied through a potential difference between the nozzle and a counter electrode. When the electric stress overcomes the surface tension, the emerging droplet from the tip of the nozzle is transformed into a conical shape. From the cone apex, a jet emerges that breaks into monodisperse droplets. This spraying mode is called the cone-jet mode. Several other spraying modes can also be obtained. Unipolarity of the droplets prevents their coagulation. The size of the droplets can range from nanometers to several microns. The utilization of a volatile liquid in the electrospray process leads to its fast evaporation resulting in droplets that shrink in size but increase in charge density. At a critical limit, corresponding to the Rayleigh charge limit, the droplets will break up into smaller droplets. Electrospraying such a liquid generates a spray of charged nanoparticle-laden droplets.

In some pharmaceutical applications, discrete particles are required. A Federal Drug Administration approved form of paliperidone palmitate, for example, has a bimodal particle size distribution having peaks at sizes 0.1 μm to 0.2 μm and from 1 μm to 2 μm. Paliperidone palmitate has a glass transition temperature (Tg) below room temperature.

When compounds that have a Tg at or below room temperature are deposited onto a substrate using an electrospray system, the particles tend to remain in an amorphous state and coalesce together, which prevents them from crystallizing and forming discrete particles.

The present inventors have discovered a need for an electrospray method for forming discrete particles from compounds having a Tg at or below room temperature, as well as a need for forming crystalline particles from such compounds.

### SUMMARY

In one aspect, the invention features a method of electrospraying particles, the method including electrospraying a liquid spray composition from a nozzle, the liquid spray composition including a liquid and a compound exhibiting a melting point and a crystallization temperature, and collecting particles formed from the liquid spray composition on a collector having a temperature that is from at least the crystallization temperature of the compound to a temperature that is less than the melting point of the compound. In one embodiment, prior to the electrospraying, the collector includes a surface having a variable topography on a nanometer scale. In another embodiment, prior to the electrospraying, nanoparticles are present on the collector. In other embodiments, prior to electrospraying, the collector includes a layer that includes the compound in crystalline form and has a thickness of less than 5 μm.

In other embodiments, the compound has a Tg no greater than room temperature

In some embodiments, the collected particles include discrete particles. In other embodiments, the collected particles include the compound in crystalline form. In some embodiments, the collected particles comprise discrete particles of the compound in crystalline form.

In other embodiments, the method further includes spraying the collected particles with organic solvent. In another embodiment, the method further includes spraying the collected particles to organic solvent for a period of time sufficient to form crystals of the compound.

In another aspect, the invention features a method of electrospraying particles, the method including electrospraying a first liquid composition from a nozzle into a second liquid composition, the first liquid composition including an organic solvent and a compound, and the second liquid composition including an organic solvent that is in a liquid state at ambient conditions. In one embodiment, the second liquid composition includes a first organic solvent and a second organic solvent different from the first organic solvent. In another embodiment, the second liquid composition further includes water. In another embodiment, the second liquid composition further includes a surfactant. In some embodiments, the second liquid composition further includes dry ice. In other embodiments, the second liquid composition is at a temperature of greater than 30° C.

In some embodiments, the particles are insoluble in the second liquid composition.

In one embodiment, the first liquid composition includes a polar organic solvent and the second liquid composition includes a nonpolar organic solvent. In other embodiments, the first liquid composition is polar and the second liquid composition is nonpolar.

In other aspects, the invention features a method of electrospraying particles, the method including electrospraying a first liquid spray composition from a nozzle onto a collector, the first liquid spray composition including a liquid and a compound, collecting particles formed from the liquid spray composition on the collector, electrospraying a second liquid spray composition on the collected particles, the second liquid spray composition comprising a volatile organic solvent, and subsequently electrospraying the first liquid spray composition from a nozzle onto the collected particles. In one embodiment, the particles are insoluble in the second liquid spray composition.

In other aspects, the invention features a method of electrospraying particles, the method including electrospraying a first liquid spray composition from a nozzle from a nozzle onto dry ice.

In another aspect, the invention features a method of electrospraying particles, the method including electrospraying a liquid spray composition from a nozzle, the liquid spray composition including a liquid and a compound, forming charged particles, neutralizing the charge on the charged particles to form neutralized particles, passing the neutralized particles through heated environment, and collecting the neutralized particles. In one embodiment, the method further includes maintaining the heated environment at a temperature that is from at least the crystallization temperature of the compound to a temperature that is less than the melting point of the compound. In another embodiment, the method further includes cooling the particles. In some embodiments, the compound exhibits a melting point and a crystallization temperature. In other embodiments, the heated environment is at a temperature that is from greater than the crystallization temperature of the compound to a temperature that is less than the melting point of the compound.

In some aspects, the invention features a method of decreasing the particle size of a compound having a Tg no greater than room temperature, the method including forming a liquid composition from a liquid and a compound having a Tg no greater than room temperature, a crystallization temperature, and a melting point, and exhibiting a first particle size, electrospraying the liquid composition from a nozzle of an electrospray system, heating the compound to a temperature that is from the crystallization temperature of the compound to less than the melting point of the compound, and collecting particles formed from the liquid composition, the collected particles exhibiting a second particle size that is less than the first particle size.

In other aspects, the invention features an electrospray system that includes a source to provide a liquid composition; a nozzle apparatus configured to receive and electrospray the liquid composition when the system is in operation; a charge neutralizer configured to receive the electrosprayed liquid composition and provide a neutralized electrospray when the system is in operation; a temperature modification apparatus to provide a temperature modified environment through which the neutralized electrospray passes when the system is in operation resulting in a temperature modified electrospray; and a collector to collect the temperature modified electrospray. In one embodiment, the temperature modification apparatus includes a heated environment. In another embodiment, the temperature modification apparatus includes a tube furnace.

In other aspects, the invention features a method of electrospraying particles, the method including electrospraying a volatile organic solvent from a nozzle onto a collector, and subsequently electrospraying a stream of particles from a nozzle onto the collector.

The invention features useful methods of electrospraying and electrospray systems.

The invention also features methods of electrospraying that can be used to make particles, or even discrete particles, of compounds having a Tg no greater than room temperature, or to decrease the particle size of compounds having a Tg no greater than room temperature relative to existing forms of the compound

The invention also features methods of electrospraying that can be used to make particles in a crystal form or to increase the rate at which electrosprayed particles crystallize.

Other features and advantages will be apparent from the following brief description of the drawings, the drawings, the description of the preferred embodiments, and from the claims.

### BRIEF DESCRIPTION OF THE DRAWINGS

FIG. 1 illustrates an embodiment of an electrospray system that includes a thermally conductive collector plate and a heating element.

FIG. 2 illustrates another embodiment of a portion of an electrospray system that includes a charge neutralizer and a tube furnace.

FIGS. 3-5 are a 40× scale microscope image, and 50 μm scale and 20 μm scale scanning electron (SEM) images, respectively, of the results of Example 1.

FIGS. 6-9 are 40× and 10× microscope images and 50 μm scale and 10 μm scale SEM images, respectively, of the results of Example 2.

FIGS. 10-13 are 40× and 10× microscope images, and 50 μm scale and 10 μm scale SEM images, respectively, of the results of Example 3.

FIGS. 14-16 are 40× and 10× microscope images, and 50 μm scale SEM images, respectively, of the results of Example 4.

FIGS. 17-19 are 40× and 10× microscope images and 100 μm scale SEM image, respectively, of the results of Example 5.

FIGS. 20-22 are 40× and 10× microscope images, and 50 μm scale SEM images, respectively, of the results of Example 6.

FIGS. 23 and 24 are 10 μm scale and 50 μm scale SEM images, respectively, of the results of Example 18.

FIGS. 25 and 26 are 50 μm scale and 100 μm scale SEM images, respectively, of the results of Example 19.

FIG. 27 is a modulated DSC thermogram (heat cycle only) of the product of Example 22a.

FIG. 28 is an X-ray profile of the product of Example 22c.

FIG. 29 is an X-ray profile of the product of Example 22b (lower curve) compared to the X-ray profile of the product of Example 22c (upper curve).

FIGS. 30A-C and 31A-C are SEM images of the powder of Example 23.

FIG. 32 are XRD profiles of the powder of Example 23.

### GLOSSARY

The term “electrospraying” means spraying a liquid that includes an organic solvent through a nozzle toward a collector in the presence of an electric field such that the fluid forms a cone jet at the spray end of the nozzle and disperses into fine droplets and the droplets are moved toward the collector.

The term “ambient conditions” means a temperature of from 20° C. to 25° C. and a pressure of 1 atmosphere.

### DETAILED DESCRIPTION

The method of electrospraying includes electrospraying a liquid spray composition that includes a compound and a liquid carrier from a nozzle in the presence of an electric field, either exposing the compound of the spray composition to an altered temperature, spraying the spray composition onto a liquid collector, spraying the spray composition onto a dynamic collector, spraying the spray composition onto a nucleating layer, spraying the spray composition onto a nanoscale variable topography collector, sequentially spraying multiple spray compositions, or a combination thereof, collecting the sprayed composition on a collector, and optionally processing the collected composition.

In one embodiment of a method of electrospraying that includes exposing a compound to an altered temperature, the compound is exposed to the altered temperature by coming in contact with a component of the electrospray system whose temperature has been altered (e.g., increased (e.g., heated) or decreased (e.g., cooled)) relative to room temperature. The temperature of any component of the electrospray system can be altered including such electrospray system components as the collector, the object being coated, the spray stream, a gas stream, the environment surrounding the electrospray system, the nozzle, and combinations thereof. Useful methods of altering the temperature of at least one component include, e.g., increasing the temperature, decreasing the temperature, and combinations thereof. The temperature can be altered in a variety of ways including, e.g., statically (e.g., an altered temperature is applied constantly), dynamically (e.g., a temperature ramped heating or cooling operation occurs, an altered temperature is applied intermittently throughout a portion of or during the entire electrospray process, and combinations thereof), and combinations thereof. Altering the temperature can occur at any point of the electrospray operation including, e.g., before, during, and after the spraying operation, and combinations thereof. The temperature of a component also can be altered using any suitable mechanism.

One useful method of electrospraying that includes exposing a compound to an altered temperature includes electrospraying a compound that exhibits a melting point and a crystallization temperature and exposing the compound to a temperature that is from at least the crystallization temperature of the compound to a temperature that is less than the melting point (Tm) of the compound by collecting the compound on a collector that is at a temperature that is from the crystallization temperature of the compound to a temperature that is less than the Tm of the compound. Preferably the compound is exposed to a temperature that is at least 5° C., at least 10° C., or even at least 15° C. above the crystallization temperature of the compound and no greater than the Tm, no greater than 20° C. below the Tm, or even no greater than 25° C. below the Tm of the compound. In one useful method of spraying paliperidone palmitate, for example, at least one component of the electrospray system (e.g., a collector plate, the object being coated, and combinations thereof) is heated to a temperature of at least about 50° C., no greater than about 80° C., no greater than about 70° C., no greater than about 60° C., from about 30° C. to about 60° C., from 40° C. to about 60° C., or even from about 50° C. to about 60° C.

Any suitable electrospray system can be used in performing the methods disclosed herein. Suitable electrospray systems, and portions thereof, that can be used or modified for use in performing the methods disclosed herein include, e.g., U.S. WO 2001/087491, WO 1998/56894, US 2014/0158787, U.S. Pat. No. 7,498,063, U.S. Pat. No. 6,764,720, U.S. Pat. No. 7,247,338 and U.S. Pat. No. 6,093,557, which are incorporated herein. Existing electrospray systems can be modified to include various components capable of providing the desired functionality including, e.g., components that alter (e.g., heat or cool) the temperature of a component of the system, components that increase capacity (e.g., integrated multiple spray nozzles), components that allow the functionality of emitting multiple spray compositions, components that neutralize particles, components that extract particles, components that collect particles (e.g., a liquid collector, a dynamic collector (e.g., dry ice), a nanoscale variable topography collector, and combinations thereof) and combinations thereof.

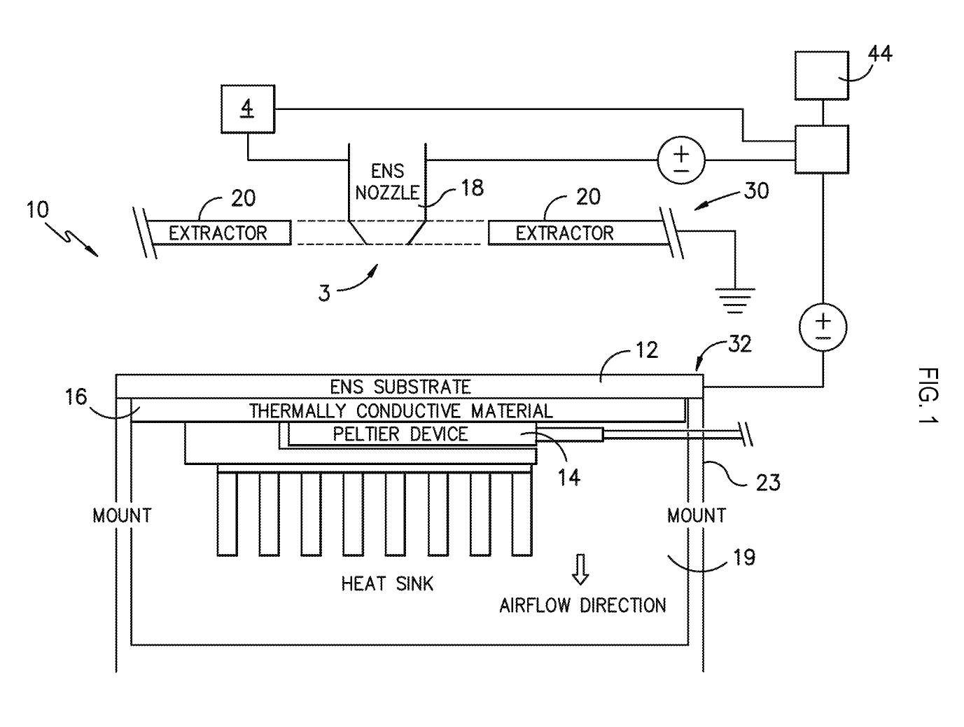

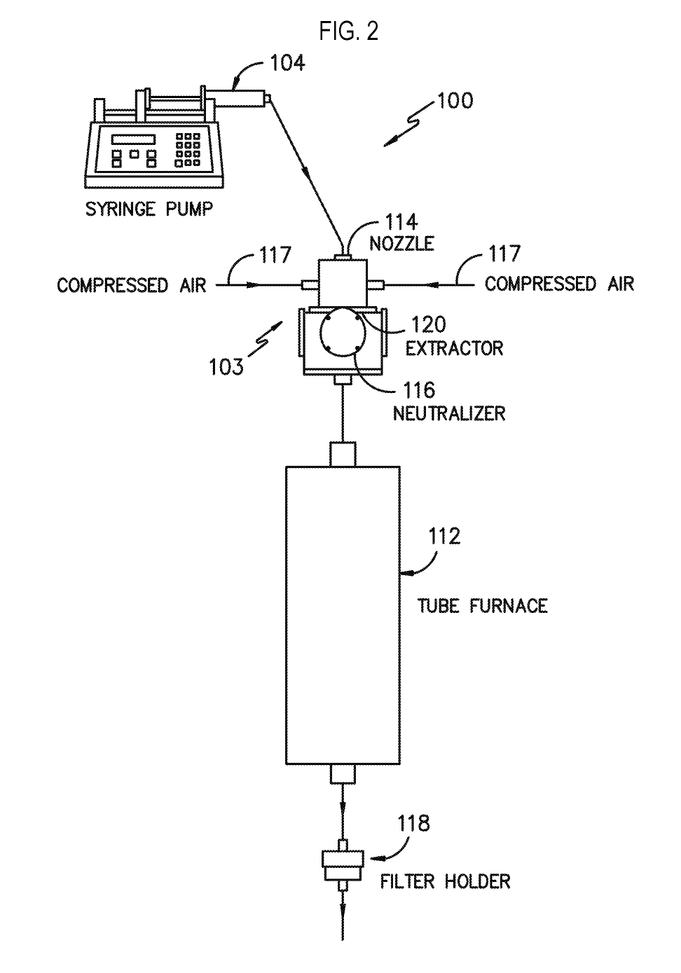

Embodiments of electrospray systems that can be used to perform at least one method described herein are shown in FIGS. 1-2. For example, as shown in FIG. 1, electrospray system 10 employs a dispensing device 3 to establish at least one spray of particles. The dispensing device 3 can include at least one nozzle structure that receives a liquid spray composition from a source 4 and establishes at least one spray of charged particles forward thereof, e.g., in the direction of a collector 12 (e.g., a target). Such nozzle structures can include, e.g., at least one capillary electrode structure (e.g., each including at least one opening at which particles or droplets are dispensed), examples of which are described in at least one of the patents or publications referenced herein, a nozzle structure that provides multiple nozzle structures (e.g., providing multiple openings at which particles or droplets are dispensed and providing multiple nozzlettes (e.g., notches and teeth) at which particles or droplets are dispensed), examples of which are described in at least one of the patents or publications referenced herein, and combinations thereof. The present disclosure is not limited to any particular nozzle structure to provide an electrospray therefrom.

The electrospray system 10 can also include an extractor 20 (e.g., an electrode) to establish a cone jet at the end of each of the nozzle structures. The extractor 20 can be coupled to a high voltage source 5 that enables a voltage to be applied to the extractor 20 or the extractor 20 can be grounded. When the nozzle 18 is at first voltage, the extractor 20 preferably is at a voltage that is relatively lower than the voltage on the nozzle 18.

The electrospray system 10 also includes a collector 12, which can collect a spray of particles provided from the at least one nozzle structure of the dispensing device 3 and that can be provided for use in various subsequent processes or for various applications (e.g., such particles can be removed from the collector for various uses). As described herein, such particles can be deposited on a variety of collectors and the electrospray system can be configured to include a variety of collectors.

The electrospray system 10 includes the high-voltage source 5 that can be coupled to the dispensing device 3 and the extractor 20 such that the high-voltage source enables a voltage to be applied to a spray end of the dispensing device 3. Similarly, the high-voltage source can be coupled to the dispensing device 3 and collector 12 such that the high voltage source enables a voltage to be applied creating a non-uniform electric field between the dispensing device 3 and the collector 12. In one exemplary embodiment, the high-voltage source 22 provides a voltage ranging from 10 kV to 30 kV to the spray end of the dispensing device 3. Alternatively, the high-voltage source can apply any voltage to the dispensing device that enables the electrospray system to function as described herein.

The at least one nozzle structure of the dispensing device 3 is positioned by (e.g., in proximity to) the extractor 20 and functions as a first electrode of the electrospray system 10. The extractor 20 is grounded or at a voltage that is relatively lower than that of the nozzle 18. The dispensing end of each nozzle structure is positioned for dispensing charged microdroplets toward the collector 12. In the exemplary embodiment of FIG. 1, to set up an electric field for delivery to the collector 12, the collector 12 functions as a second electrode structure 32. An electrical potential difference is applied between the first electrode conductive structure 30 and the extractor 20, conductive structure 30 and the second electrode or collector structure 32, which is electrically isolated from the first electrode structure 30 The collector 32 can be grounded or at a high voltage different from that of the nozzle 18 (e.g., a negative voltage if the nozzle 18 is at a positive voltage). One skilled in the art will recognize that the first and second electrode structures 30 and 32 can be formed using conductive elements and such first and second electrode structures 30 and 32 can take any of a variety of different configurations.

The electrospray system 10 can further include the source 4 (e.g., a controllable syringe pump) for providing at least one liquid spray composition to the at least one nozzle structure of the dispensing device 3. In at least one embodiment, each nozzle structure can be configured to provide a single spray of particles from at least one source of liquid spray composition, from two different sources of liquid spray composition, or even from three different sources of liquid spray composition. The at least one spray established forward of each nozzle structure can be provided to the collector 12.

The electrospray system 10 can also include a control mechanism 40, e.g. hardware and software that can be used to control high voltage source 5 and material source 4 (e.g., a liquid source or sources). The control mechanism 40 can include any number of control apparatus components (e.g., any number of processors 42, controllers, memory, software or hardware, displays, input devices, user interfaces 44 and any combination thereof) as needed for carrying out the control functionality of the electrospray system 10 as described herein (e.g., control of furnace components, neutralizers, any other system components described herein, and any combination thereof).

The nozzle 18 of the dispensing device 3 positioned by the extractor portion 20 functions as the first electrode structure of the electrospray system 30 with the dispensing end or ends of the nozzles or nozzle structures 18 being positioned for dispensing charged microdroplets toward a collector 12. The first electrode structure including the nozzle 18 is connected to the high voltage source 5, the extractor 20 can be connected to ground or connected to a voltage source (e.g., to receive a voltage that is lower than the voltage applied to the nozzle), and the collector 12 can be grounded or connected to a high voltage source (e.g., to receive a voltage that is lower than the voltage applied to the nozzle). For example, a high positive voltage can be applied to establish a non-uniform field between the electrode of the nozzle 18 and the extractor 20 or between the nozzle 18 and the collector 12. The non-uniform electric field herein refers to an electric field created by an electrical potential difference between two electrodes. The non-uniform electric field includes at least some electric field lines that are more locally concentrated at one electrode relative to the other electrode.

The liquid spray composition, which has an electrical conductivity, is flowed through at least one opening of nozzle 18. As the liquid spray composition progresses through the opening of the nozzle 18, the potential difference between the collector 12 and the nozzle 18, or the nozzle 18 and the extractor 20, creates the electric field there between and strips the liquid of one polarity of charge, e.g., the negative charge is stripped when a high positive voltage is applied to the nozzle 18, leaving positively charged microdroplets to be dispensed from the nozzle 18. For example, the meniscus at the electrode of each nozzle structure of the nozzle 18 (e.g., at a tip of the at least one nozzle structures) can form a cone jet for dispensing a spray of microdroplets when forces of a non-uniform field balance the surface tension of the meniscus. The spray of microdroplets can further become more positive in a non-uniform electric field.

As the microdroplets evaporate, the charge on the microdroplets concentrates and results in a spray of charged particles. The amount of charge on the microdroplet, and thus the amount of charge on a particle after evaporation, is based at least upon the conductivity, the surface tension, the dielectric constant, and the feed flow rate of the liquid spray composition. Generally, the electric charge concentrated on a particular particle is from about 80% to about 95% of a maximum charge that can be held by the microdroplets, without the microdroplet being shattered or torn apart, i.e., from about 80% to about 95% of the Rayleigh charge limit. At 100% of the Rayleigh charge limit, the surface tension of the microdroplet is overcome by the electric forces causing droplet disintegration. The non-uniform electric field also provides for containment of particles, direction for the particles, which would otherwise proceed in random directions due to the space charge effect, and combinations thereof

### Thermally Conductive Collector Plate

In one embodiment of the electrospray system, the electrospray system 10 includes the nozzle 18, the extractor 20, the collector plate 12, a heating element 14 (e.g., a conductive resistive element having a voltage applied thereto to generate heat, a thermoelectric heating element, electric resistance heating element, an induction heating element, or any other suitable heating element), and a thermally conductive, electrically insulating material 16 positioned against the collector plate 12, as shown in FIG. 1.

The heating element and the thermally conductive nature of the electrically insulating material enables the system 10 to heat the collector plate and the electrically insulating nature of the material enables the equipment (e.g., the heating element) used to heat the collector plate to be electrically insulated from the voltage being applied to the collector plate. The system is configured so as to electrically insulate the components of the heating apparatus from the charged or grounded collector plate, the voltage applied to the system, and combinations thereof. Useful thermally conductive, electrically insulating materials include, e.g., metal oxides, metal nitrides ceramic materials, diamond, charcoal, and combinations thereof. Specific thermally conductive, electrically insulating materials include, e.g., beryllium oxide, aluminum oxide, zinc oxide, boron nitride, aluminum nitride, magnesium nitride, silicon carbide, tungsten carbide, and combinations thereof. The thermally conductive, electrically insulating materials can also be in a variety of forms including, e.g., composites, multilayer constructions (e.g., continuous and discontinuous layers), and combinations thereof.

Useful collector plates that can be heated by the heating element include, e.g., plates or coupons made from a variety of materials that are heat conducting, electrically conducting, and combinations thereof including, e.g., stainless steel, copper, nickel, silver, gold, aluminum, brass, iron, lead, and alloys, and combinations thereof.

Further, a heatsink 19 can be coupled to thermally conduct heat from the thermally conductive, electrically insulating material 16. Still further, any suitable mounting apparatus and hardware can be used to couple at least one of such system components as shown generally by mount apparatus 23.

In another embodiment of the electrospray system, the electrospray system can include a cooling element (e.g., a conductive resistive element having a voltage applied thereto to generate heat, a Peltier cooler, a thermoelectric cooler, a cooling coil, a heat exchanger, an evaporator, a cryogenic liquid, a cryogenic solid, and combinations thereof), and a thermally conductive, electrically insulating material positioned against the collector plate. The cooling element and the thermally conductive nature of the electrically insulating material enable the system to cool the collector plate and the electrically insulating material enables the equipment used to cool the collector plate to be electrically insulated from the voltage being applied to the collector plate. The system is configured so as to electrically insulate the components of the cooling apparatus from the charged or grounded collector plate, the voltage applied to the system, and combinations thereof.

Liquid Collector

In some embodiments of the electrospray system, the collector includes a liquid and the liquid spray composition is sprayed toward the liquid collector. The liquid collector can be held in a vessel and a voltage can be applied to the vessel or the vessel can be grounded. The vessel can be electrically conductive or non-conductive. The vessel can be made from a variety of materials including, e.g., glass, stainless steel, copper, nickel, silver, gold, aluminum, brass, iron, lead, and alloys and combinations thereof. The collector liquid optionally is in motion (e.g., a moving stream of liquid, rotating liquid, vibrating liquid, and combinations thereof). A collector plate can be located in the collector liquid, and the collector plate optionally can have a voltage applied thereto or can be grounded. In other embodiments, energy can be applied to the liquid of the collector to impart motion to the liquid (e.g., moving a stream of the liquid along a path, rotating the liquid, vibrating the liquid, and combinations thereof), and can pass through the vessel to at least one of a second collector and a further processing station.

Energy can be applied to or removed from the liquid collector in a variety of forms including, e.g., heating, cooling, sonicating, shaking, mixing, creating turbulence, laminar flow, and combinations thereof, using any suitable energy applying equipment including, e.g., heating elements, cooling elements, sonicators, shakers, mixers (e.g., to achieve a rotating liquid or a turbulent liquid), pumps, turbulence generators, laminar flow systems, and combinations thereof. Energy also can be applied to the system so as to carry away the particles deposited in the liquid or on the surface of the liquid, and to provide a fresh liquid surface onto which future particles can be sprayed and collected.

In one embodiment of the method of electrospraying using an electrospray system that includes a liquid collector, the method includes electrospraying a liquid spray composition includes an organic solvent and a compound from a nozzle into a liquid collector and optionally at least one of applying or removing energy from the liquid collector, removing particles formed by the electrospraying process from the liquid collector, and further processing the particles.

The liquid collector includes an organic solvent that is in a liquid state at ambient conditions. The liquid collector includes at least 10% by volume, at least 20% by volume, at least 40% by volume, at least 50% by volume, at least 60% by volume, at least 70% by volume, or even at least 80% by volume organic solvent. At least one of the compound being sprayed and the particles formed from the liquid spray composition preferably are insoluble in the collector liquid. Useful collector liquids include, e.g., organic solvent that is in a liquid state at ambient conditions, polar liquids, nonpolar liquids, liquids that are volatile and readily evaporate at room temperature (i.e., from 20° C. to 25° C.), liquids that evaporate upon heating in an oven at a suitable temperature (e.g., below the melting point, the crystallization temperature, or even the Tg of the compound being sprayed, and combinations thereof).

The collector liquid can be any suitable liquid including, e.g., liquid nitrogen, a polar organic liquid, a nonpolar organic liquid, and combinations thereof. Suitable polar liquids include, e.g., water, methanol, ethanol, propanol, isopropanol, butanol, hexanol, acetic acid, acetone, acetonitrile, tetrahydrofuran, dimethyl sulfoxide, C3-6 amides (e.g., dimethylacetamide and dimethylformamide), C3-6 ketones (acetone, methyl ethyl ketone, and methyl isobutyl ketone), ammonia, and combinations thereof. Suitable nonpolar liquids include, e.g., toluene, dichloromethane, dichloroethane, dichlorobenzene, dimethylamine, hydrocarbons (e.g., pentane, hexane, and cylcohexane), C6-12 aromatic hydrocarbons (e.g., benzene, toluene, o-xylene, p-xylene and m-xylene), C2-6 alkyl acetates (e.g., ethyl acetate and isobutyl acetate), C2-8 ethers (e.g., diethoxymethane, isobutyl methyl ether, diethyl ether, dibutyl ether, and polyethylene glycol methyl ether), chloroform, and combinations thereof.

The liquid collector optionally includes additional components including, e.g., wetting agents (e.g., surfactants), suspending agents, polymers, excipients, other solvents, additional compounds (e.g., second drug compound when the spray liquid composition includes a first drug compound), and combinations thereof.

Wetting agents can be added to the liquid collector to facilitate movement of the particles into the body of the liquid. Useful wetting agents include, e.g., polyoxyethylene derivatives of sorbitan esters, e.g. polysorbate 20 (i.e., polyethylene glycol 20 sorbitan monolaurate), polysorbate 80 (i.e., TWEEN 80 polyethylene 20 sorbitan monooleate), lecithin, polyoxyethylene- and polyoxypropylene ethers, sodium deoxycholate, and combinations thereof.

Useful suspending agents include, e.g., cellulose derivatives, including, e.g. methyl cellulose, sodium carboxymethyl cellulose and hydroxypropyl methyl cellulose, polyvinylpyrrolidone, alginates, chitosan, dextrans, gelatin, polyethylene glycols, polyoxyethylene- and polyoxypropylene ethers, and combinations thereof.

The liquid collector can be at any suitable temperature including, e.g., chilled (e.g., no greater than 15° C., no greater than 0° C., no greater than −20° C., or even no greater than −50° C.), or heated (e.g., at least 30° C., at least 40° C. or even at least 50° C.),

Dynamic Collector

In other embodiments of the electrospray system, the collector is dynamic such the collector is in motion during the spray operation, the surface topography of the collector is changing over time during the spray operation, and combinations thereof. One example of a dynamic collector that is in motion is a moving liquid in a liquid collector as described above in reference to the liquid collector. Another suitable dynamic collector is dry ice (i.e., solid carbon dioxide) and collectors that include dry ice and a liquid (e.g., liquid nitrogen, water, an organic solvent, and combinations thereof).

In one embodiment of a method of electrospraying using an electrospray system that includes a dynamic collector, the method includes electrospraying a liquid spray composition from a nozzle onto a dynamic collector that includes as least one of dry ice and liquid in motion. When particles are sprayed onto a dynamic collector, a particle's location may change relative to its initial location creating a new or modified surface on which the next particle being sprayed can land, alternatively or in addition, the topography of the dynamic collector can change during the spray process. The change in the topography of the collector can be on a variety of scales including, e.g., micrometer scale and nanometer scale. The changing topography can function to separate the particles as they are being deposited so as to keep the particles from contacting one another and to allow crystal growth. Such collector components optionally are provided in a collector vessel as described herein with reference to a liquid collector.

In some embodiments, the topography of the dry ice changes as particles of the compound deposit on the surface of the dry ice, which in turn alters the surface onto which subsequent particles are deposited and in some instances provides a fresh surface for subsequent particle deposition. Portions of the fresh surface are free of particles. When additional particles are deposited, they are free of contact with other particles and preferably form discrete particles. Alternatively, or in addition, during the electrospray process, as the dry ice sublimes (i.e., evaporates), the collected particles are left behind. The sublimation of the dry ice as the spray of particles is being deposited on the surface thereof creates an ever changing surface, which can facilitate the separation of the sprayed particles, decrease the agglomeration of particles, and cause subsequently deposited particles to deposit in a different area relative to a previously deposited particle. The sublimation action also optionally causes the collected particles to break apart into smaller particles.

In one embodiment of the method of electrospraying that utilizes a dry ice collector, the method optionally further includes at least one of transferring the collector and collected particles to a temperature controlled environment exhibiting a low temperature, such as a freezer, and allowing the dry ice to sublime. Useful controlled low temperature environments include environments at a temperature of from about −25° C. to about 10° C., from about −10° C. to about 8° C., or even from about 0° C. to about 8° C. As the dry ice sublimes it leaves behind the particles or a slurry of particles that includes any liquid, e.g., organic liquid that optionally was present in the initial collector system.

Altered Temperature of the Flight Path of the Spray Composition

In other embodiments of the electrospray system, the electrospray system includes an apparatus for altering the temperature (e.g., heating and chilling) of the environment through which the liquid spray composition passes during the spray operation, the temperature of the liquid spray composition, and combinations thereof. In one useful method, heat is applied to the liquid spray composition, the flight path through which the liquid spray composition passes from the nozzle to the collector, or a combination thereof. Heat can be applied using a variety of mechanisms including, e.g., ambient heat, radiant heat, infrared radiation, a heated gas stream (e.g., air, nitrogen, carbon dioxide, and combinations thereof), and combinations thereof. Heat can be applied in a variety of configurations including, e.g., supplying a heated gas stream from a channel that is coaxial with the spray of compound being emitted from the nozzle, directing heat (e.g., radiant energy, a heated gas stream, and combinations thereof) at the spray of particles or flight path at any suitable angle to the flight path (e.g., substantially perpendicular to the flight path), and combinations thereof.

One useful method of heating the flight path of the spray of particles utilizes an electrospray system 100 that includes a tube furnace 112, one example of which is shown in FIG. 2. The electrospray system 100 can include any components described with reference to FIG. 1 that are needed to provide an electrospray using such a tube furnace. For example, the electrospray system 100 can include a dispensing device 103 to establish at least one spray of particles. The dispensing device 103 can include at least one nozzle structure 114 that receives a liquid spray composition from a source (e.g., syringe pump 104) and establishes at least one charged spray of particles forward thereof, e.g., in the direction of a collector 118 (e.g., a target).

The electrospray system 100 can also include an extractor 120 (e.g., a ring electrode or a plate with multiple openings through which individual spray structures (e.g., nozzles) can spray) to establish a cone jet at the end of each of the nozzle structures. The electrospray system 100 can include the high-voltage source, which can be coupled to the nozzle 114 of the dispensing device 103 and the extractor 120 can be coupled to ground creating a non-uniform electric field. Further, the electrospray system 100 can also include a control mechanism, e.g. hardware and software that can be used to control high voltage source and source 104, to carry out, as needed, the control functionality of the electrospray system 100 as described herein (e.g., control of furnace components, neutralizers, any other system components described herein), and combinations thereof.

As the liquid spray composition progresses through the nozzle 114, the potential difference between the extractor 120 and the nozzle 114 creates the electric field there between and strips the liquid of one polarity of charge, e.g., the negative charge is stripped when a high positive voltage is applied to the nozzle 18, leaving a positively charged microdroplet to be dispensed from the nozzle 18.

Microdroplets of the liquid spray composition can be formed forward of the cone-jet on the nozzle 114, and can be passed through a charge neutralizer 116 (e.g., with use of the compressed air 117 provided through the nozzle structure 114). The charge neutralizer 116 neutralizes the charge on the particles formed by the droplets emitted by the cone jets. The charge neutralizer 116 can generate an electric charge of opposite polarity to that of the charged particles near the spray of charged particles to neutralize the charged particles. Any suitable device capable of neutralizing the charge on the particles can be used including any device that provides charge neutralization using, e.g., radioactive material, X-rays (e.g., a soft X-ray charge neutralizer or a hard X-ray charge neutralizer, both of which can be used to irradiate the charged particles with X rays), corona discharge, and combinations thereof. A variety of suitable neutralizers are commercially available including, e.g., radioactive and nonradioactive aerosol neutralizers commercially available from TSI Incorporated (Shoreview, Minn.) including, e.g., AEROSOL NEUTRALIZER 348002.

The neutralized particles can then be passed through a heated or cooled environment (e.g., relative to ambient or room temperature) provided by a temperature modification apparatus, which can be coupled to the neutralizer forming a path there between. Any suitable temperature modification apparatus may be used that may increase or decrease the temperature of the electrospray.

One useful temperature modification apparatus is the tube furnace 112. Any suitable tube furnace can be used that can apply heat to the spray of particles. Useful commercially available tube furnaces include, e.g., tube furnaces available from Thermo Fisher Scientific (Waltham, Mass.) and CARBOLITE tube furnaces available from Carbolite (Hope Valley, United Kingdom) and from Verder Scientific, Inc. (Newtown, Pa.). In some embodiments, a gas (e.g., oxygen, air, nitrogen, and combinations thereof) flows through the tube furnace. Heat can be applied to the spray of particles as the particles pass through an opening extending through the tube furnace 112. The temperature of the gas, and the environment within the tube furnace, can be static or dynamic, e.g., ramped at a periodic rate. The environment in the tube furnace optionally is heated to a temperature from at least the crystallization temperature of the compound being sprayed, or even from greater than the crystallization temperature of the compound being sprayed (e.g., at least 5° C., at least 10° C., or even at least 15° C. above the crystallization temperature of the compound being sprayed) to a temperature that is below the melting point of the compound being sprayed.

The heated spray of particles can be provided from the tube furnace 112 to a collector 118. The particles are collected at the exit of the tube furnace 112 using any suitable collector or technique including, e.g., in a cyclone collector (e.g., using cyclone separation techniques), an impactor, a filter, any other device suitable for collecting aerosol particles, other collectors described herein, and combinations thereof.

In another useful method, the temperature of the spray of particles or the flight path of the particles being sprayed is decreased (e.g., chilled). The temperature can be decreased using a variety of mechanisms including, e.g., ambient chilling, a cooled gas stream (e.g., air, nitrogen (e.g., a liquefied nitrogen gas), and combinations thereof), and combinations thereof. Chilling can be achieved using a variety of configurations including, e.g., supplying a chilled gas stream from a channel that is coaxial with the liquid spray composition emitted from a nozzle, directing a liquefied gas (e.g., nitrogen) at the spray of particles or flight path at any suitable angle to the flight path (e.g., substantially perpendicular to the flight path), and combinations thereof.

### Optional Processing

The methods of electrospraying disclosed herein optionally include additional processing steps. One useful processing step includes exposing sprayed particles to vapors organic solvent vapor (e.g., placing the sprayed particles in an environment saturated with vapors of organic solvents including, e.g., the above-described organic solvents, spraying organic solvent on the particles, and combinations thereof), preferably for a period of time sufficient to allow the compound of the spray composition to form crystals. Another useful processing step includes separating collected particles from one another, processing the sprayed composition to form discrete particles, de-agglomerating collected particles (e.g., using any suitable force including, e.g., mechanical force (e.g., scraping and mixing), acoustical force (e.g., the force exerted by a RESODYN acoustic mixer from Resodyn Acoustic Mixers, Inc. (Butte, Mont.), vibrational force, rotational force, formulating the particles with other components (e.g., excipients, fillers, wetting agents (e.g., surfactants), suspending agents, polymers, and other compounds used in pharmaceutical compositions), and combinations thereof.

The electrospray method optionally further includes heating the particles to a temperature that is greater than the crystallization temperature of the particles and less than the melting point of the particles, and then cooling the particles. The cooled particles preferably are crystalline in form, or even in the form of discrete crystalline particles. Cooling the particles preferably occurs sufficiently fast so that the crystalline particles do not increase in size, e.g., due to merging of adjacent crystalline particles.

### Product

The composition collected on the collector can be in a variety of forms including, e.g., particles, a film (e.g., a continuous or a discontinuous film), and combinations thereof. The collected composition optionally is removed from the collector and optionally further processed to obtain discrete particles or even discrete particles of the compound in crystalline form. Discrete particles are particles that are not agglomerated or fused together. Agglomerated and fused particles are discrete particles if the average cross-sectional dimension of the fused or agglomerated particle is no greater than 2 μm. Preferably the largest cross-sectional dimension of the particles is less than 10 μm, less than 5 μm, less than 2 μm, less than 1 μm, or even less than 500 nanometers (nm).

### Uses

The methods of electrospraying and the electrospray systems are useful for a variety of purposes including, e.g., forming films, forming particles (e.g., discrete particles, crystalline particles, discrete crystalline particles, agglomerated particles, and combinations thereof), making discrete particles from a compound having a Tg no greater than room temperature, making discrete crystalline particles from a compound having a Tg no greater than room temperature, increasing the crystallization rate of the compound being sprayed, decreasing the particle size of a compound having a Tg no greater than room temperature relative to existing forms of the compound, and combinations thereof.

### Liquid Spray Composition

The liquid spray composition includes a liquid carrier and a compound and can be in any suitable form including a solution, a suspension, an emulsion, a dispersion, and combinations thereof. A variety of liquid spray compositions are suitable for use in the methods of electrospraying. One class of useful liquid spray compositions includes a liquid carrier and a compound that has a crystallization temperature, a melt point (Tm), and optionally a glass transition temperature (Tg). A variety of compounds can be included in the liquid spray composition. The method is particularly useful for spraying compounds that have a Tg no greater than room temperature (i.e., from about 20° C. to about 25° C.). Specific examples of drug compounds having a Tg no greater than room temperature are set forth below in Table 1 along with the reported melting points thereof (in degrees Kelvin and Celsius).

TABLE 1

| Compound | Tg (K) | Tg ° C. | Tm (K) | Tm ° C. |
|---|---|---|---|---|
| dibucaine | 238 | −35 | 339 | 66 |
| Aspirin | 243 | −30 | 409 | 136 |
| antipyrine | 256 | −17 | 387 | 114 |
| flurbiprofen | 267 | −6 | 388 | 115 |
| flutamide | 271 | −2 | 384 | 111 |
| ketoprofen | 271 | −2 | 368 | 95 |
| tolbutamide | 277 | 4 | 359 | 86 |
| salsalate | 278 | 5 | 402 | 129 |
| naproxen | 279 | 6 | 418 | 145 |
| cinnarizine | 280 | 7 | 428 | 155 |
| aceclofenac | 283 | 10 | 394 | 121 |
| mevastatin | 288 | 15 | 426 | 153 |
| bifonazole | 290 | 17 | 428 | 155 |
| tolazamide | 291 | 18 | 424 | 151 |
| nimesulide | 294 | 21 | 445 | 172 |
| paracetamol | 294 | 21 | 423 | 150 |

Examples of other drug compounds that can be sprayed using the methods disclosed herein are set forth in Table 2.

TABLE 2

| Compound | Tg (K) | Tg ° C. | Tm (K) | Tm ° C. |
|---|---|---|---|---|
| acetominophen | 297 | 24 | 443 | 170 |
| probucol | 300 | 27 | 400 | 127 |
| droperidol | 302 | 29 | 416 | 143 |
| lidocaine HCl | 303 | 30 | 341.5 | 68.5 |
| simvastatin | 305 | 32 | 419 | 146 |
| cimetidine | 309 | 36 | 408 | 135 |
| indomethacin | 318 | 45 | 415 | 142 |

The values in Tables 1 and 2 are as reported in multiple literature sources including, e.g., Trasi, Niraj S., et al., “Factors Influencing Crystal Growth Rates from undercooled Liquids of Pharmaceutical Compounds,”J. Phys. Chem., B 2014; 118:9974-9982, and in Martinez L M, et al., “Stabilization of amorphous paracetamol based systems using traditional and novel strategies,” Int J Pharm. 2014 Dec. 30; 477(1-2):294-305, and were obtained using a differential scanning calorimeter.

The liquid spray composition can include any suitable liquid carrier, useful examples of which include the liquids set forth above including, e.g., water, methanol, ethanol, isopropanol, butanol, acetone, acetonitrile, tetrahydrofuran, dimethyl sulfoxide, C3-6 amides (dimethylacetamide and dimethylformamide), C3-6 ketones (acetone, methyl ethyl ketone, and methyl isobutyl ketone), toluene, dichloromethane, dimethylamine, C6-12 aromatic hydrocarbons (benzene, toluene, o-xylene, p-xylene and m-xylene), C2-6 alkyl acetates (e.g., ethyl acetate and isobutyl acetate), C2-8 ethers (diethoxymethane, isobutyl methyl ether, dibutyl ether, and polyethylene glycol methyl ether), and combinations thereof.

The carrier liquid preferably dries (e.g., evaporates) rapidly.

The liquid spray composition optionally includes additional components including, e.g., wetting agents (e.g., surfactants), suspending agents, polymers, excipients, other solvents, more than one compound (e.g., more than one drug compound), and combinations thereof.

Useful wetting agents include, e.g., polyoxyethylene derivatives of sorbitan esters, e.g. polysorbate 20 (i.e., polyethylene glycol 20 sorbitan monolaurate), polysorbate 80 (i.e., TWEEN 80 polyethylene 20 sorbitan monooleate), lecithin, polyoxyethylene- and polyoxypropylene ethers, sodium deoxycholate, and combinations thereof.

Useful suspending agents include, e.g., cellulose derivatives, including, e.g. methyl cellulose, sodium carboxymethyl cellulose and hydroxypropyl methyl cellulose, polyvinylpyrrolidone, alginates, chitosan, dextrans, gelatin, polyethylene glycols, polyoxyethylene- and polyoxypropylene ethers, and combinations thereof.

Polymer

A variety of polymers are suitable for use in the spray composition including, e.g., crystalline polymers, semi-crystalline polymers, amorphous polymers, water insoluble polymers, water soluble polymers, organic solvent soluble polymers, organic solvent insoluble polymers, FaSSIF soluble polymers, FaSSGF soluble polymers, swellable polymers (e.g., polymers that swell in water, FaSSIF, FaSSGF, and in combinations thereof), and combinations thereof. Other useful classes of polymers include, e.g., polymers that include proton acceptors (e.g., cationic polymers), polymers that include proton donors (e.g., anionic polymers), polymers with surfactant properties, and combinations thereof including, e.g., proton donating copolymers of methacrylic acid and ethyl acrylate, proton accepting copolymers of dimethylaminoethyl methacrylate, butyl methacrylate, and methyl methacrylate, polyvinyl caprolactam-polyvinyl acetate-polyethylene glycol graft copolymer, and combinations thereof.

Suitable amorphous polymers include, e.g., polyvinyl alcohol, polyvinyl acetate, polyvinyl pyrrolidone, hyaluronic acid, alginates, carrageenan, cellulose derivatives (e.g., carboxymethyl cellulose sodium, methyl cellulose, ethyl cellulose, hydroxyethyl cellulose, hydroxypropylmethylcellulose-phthalate, cellulose acetate phthalate, and combinations thereof), non-crystalline cellulose, starch and its derivatives (e.g., hydroxyethyl starch, sodium starch glycolate, and combinations thereof), chitosan and its derivatives, albumen, gelatin, collagen, polyacrylates and polyacrylate derivatives, poly(alpha-hydroxy acids), poly(alpha-aminoacids) and copolymers thereof, poly(orthoesters), polyphosphazenes, poly(phosphoesters), hydroxypropylmethylcellulose-acetate-succinate, and combinations thereof. Useful polymers include functional groups capable of promoting specific interaction with an active agent to help stabilize the amorphous form of the agent.

Suitable water insoluble amorphous polymers include, e.g., polyvinyl acetate, methyl cellulose, ethyl cellulose, non-crystalline cellulose, polyacrylates, polymethacrylates, poly(alpha-hydroxy acids), poly(orthoesters), polyphosphazenes, poly(phosphoesters), and combinations thereof.

Useful commercially available amorphous polymers are available under a variety of trade designations including, e.g., the EUDRAGIT series of trade designations from Evonik (Germany), including EUDRAGIT L100-55 anionic copolymer and EUDRAGIT E100 cationic copolymer, K30 polyvinylpyrrolidone from Sigma-Alrdrich Co. LLC (St. Louis, Mo.) and under the SOLUPLUS series of trade designations from BASF, (Ludwigshafen, Germany) including, e.g., SOLUPLUS polyvinyl caprolactam-polyvinyl acetate-polyethylene glycol grafted copolymer powder.

The invention will now be described by way of the following examples. All parts, ratios, percentages and amounts stated in the Examples are by weight unless otherwise specified.

### EXAMPLES

### Test Procedures

Test procedures used in the examples include the following. All solvent ratios and are volume to volume and solute percentages are by weight per volume (100%×grams per milliliter (g/ml)) unless otherwise indicated. The procedures are conducted at room temperature (i.e., an ambient temperature of from about 20° C. to about 25° C.) unless otherwise specified.

### Electrospray System Parameters A

An electrospray system is configured to operate in a cone jet mode with a spray nozzle, a syringe for feeding the liquid spray composition to the spray nozzle, a collector, and an extractor. The main voltage is at 29.7 kilovolts (kV), the extractor voltage is at 10.0 kV, the nozzle is positioned 3.0 inches (in) from the spray collector, and the liquid spray composition flow rate is 120 microliters per minute (μL/min).

### Process for Heating a Collector Substrate

A collector substrate is heated in an oven to the specified temperature and then, just prior to the spraying process, removed from the oven and positioned underneath the spray nozzle to receive the spray.

### Raw Materials

Paliperidone palmitate crystalline powder (lot#140327-1) from API Vanguard (Baldwin Park, Calif.)

Tween 20 HP polyethylene glycol sorbitan monolaurate, from Croda (Edison, N.J.

PEG-4000 polyethylene glycol having a molecular weight of 4000 grams per mole from Bioworld (Dublin, Ohio)

### Example 1

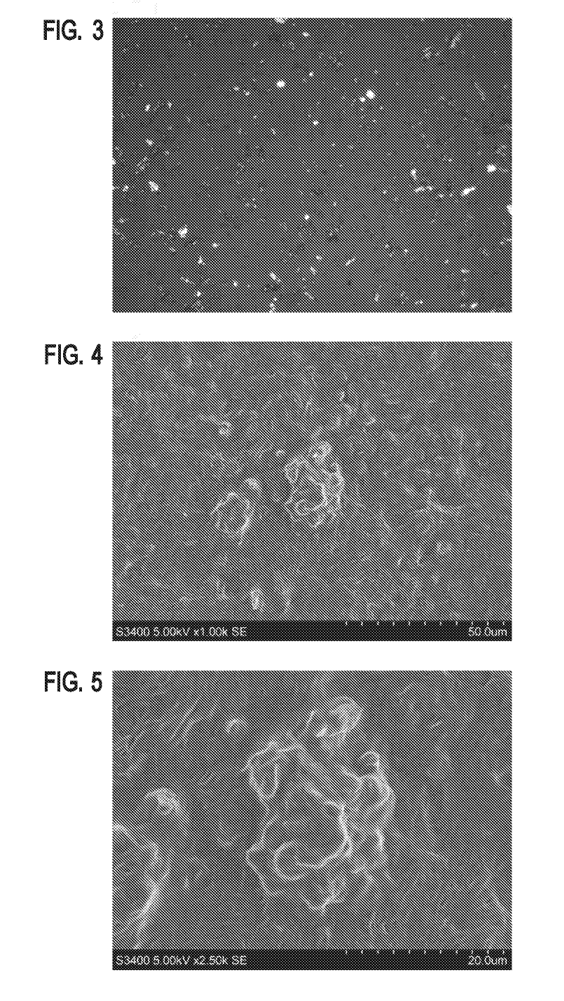

A liquid spray composition of 1:0.19:0.077 paliperidone palmitate:polyethylene glycol:Tween 20 in 70:30 (volume to volume) methanol:toluene was prepared and sprayed for two minutes onto a stainless steel plate, which was at a temperature of approximately 80° C., using Electrospray System Parameters A with the exception that the extractor voltage was 11.8 kV. The result is shown in the 40× microscope image of FIG. 3 and the 50 μm and 20 μm scale scanning electron images of FIGS. 4 and 5, respectively.

### Example 2

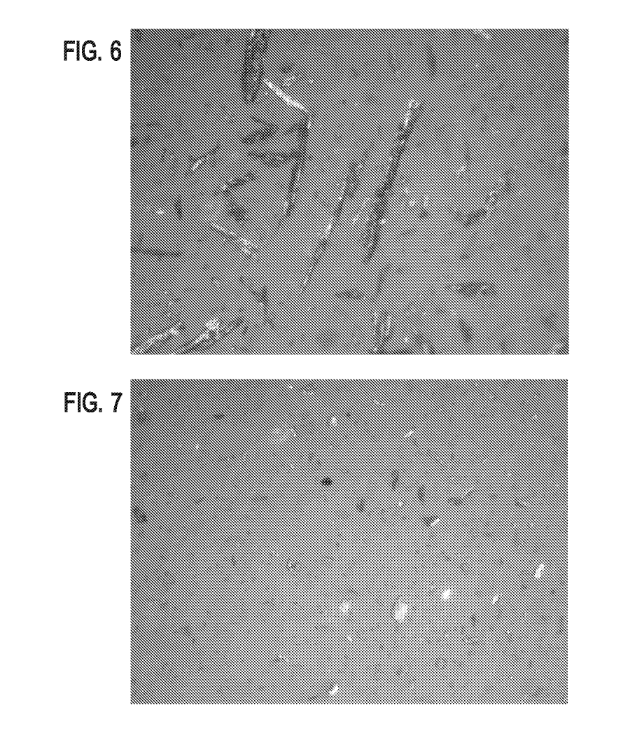

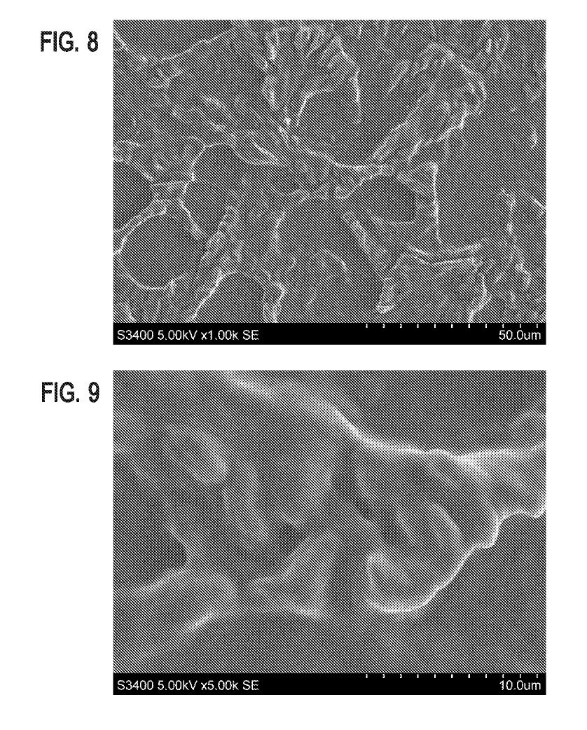

A liquid spray composition of 1:0.077 paliperidone palmitate:Tween 20 in 70:30 (v:v) methanol:toluene was prepared and sprayed for five minutes onto a stainless steel plate, which was at a temperature of approximately 70° C., using Electrospray System Parameters A with the exception that the voltage of the extractor was 12.1 kV. The results are shown in the 40× and 10× microscope images of FIGS. 6 and 7, respectively, and the 50 μm and 10 μm scale scanning electron images of FIGS. 8 and 9, respectively.

### Example 3

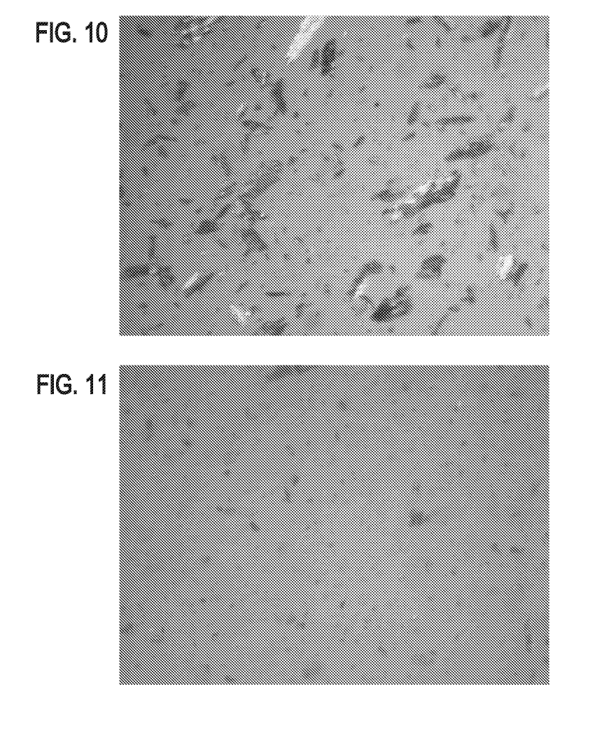

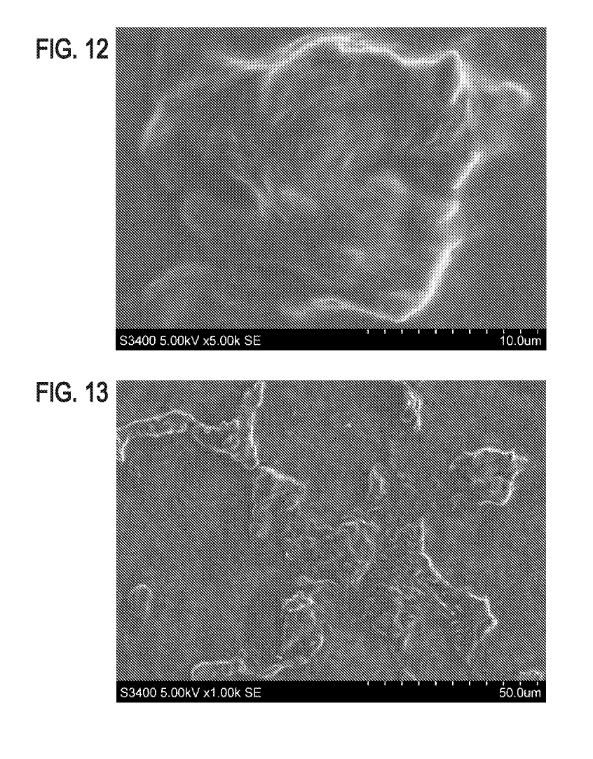

A liquid spray composition of 1:0.19:0.077 paliperidone palmitate:polyethylene glycol:Tween 20 in 70:30 (v:v) methanol:toluene and 0.04 mg/mL ammonium acetone was prepared and sprayed for five minutes onto a stainless steel plate, which was at a temperature of approximately 70° C., using Electrospray System Parameters A with the exception that the main voltage was 29.6 kV and the extractor voltage was 18.8 kV. The results are shown in the 40× and 10× microscope images of FIGS. 10 and 11, respectively, and the 50 μm and 10 μm scale scanning electron images of FIGS. 12 and 13, respectively.

### Example 4

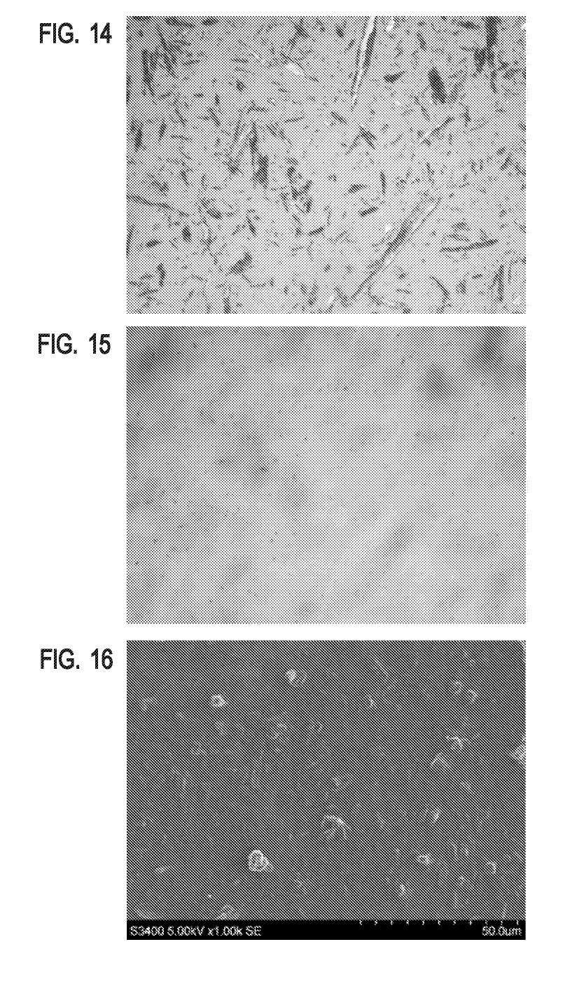

A liquid spray composition of 1:0.077 paliperidone palmitate:Tween 20 in 70:30 (v:v) methanol:toluene and 0.04 mg/mL ammonium acetate was prepared and sprayed for five minutes onto a stainless steel plate, which was at a temperature of approximately 67° C., using Electrospray System Parameters A with the exception that the main voltage was 29.3 kV and the extractor voltage was 18.8 kV. The results are shown in the 40× and 10× microscope images of FIGS. 14 and 15, respectively, and the 50 μm scale scanning electron image of FIG. 16.

### Example 5

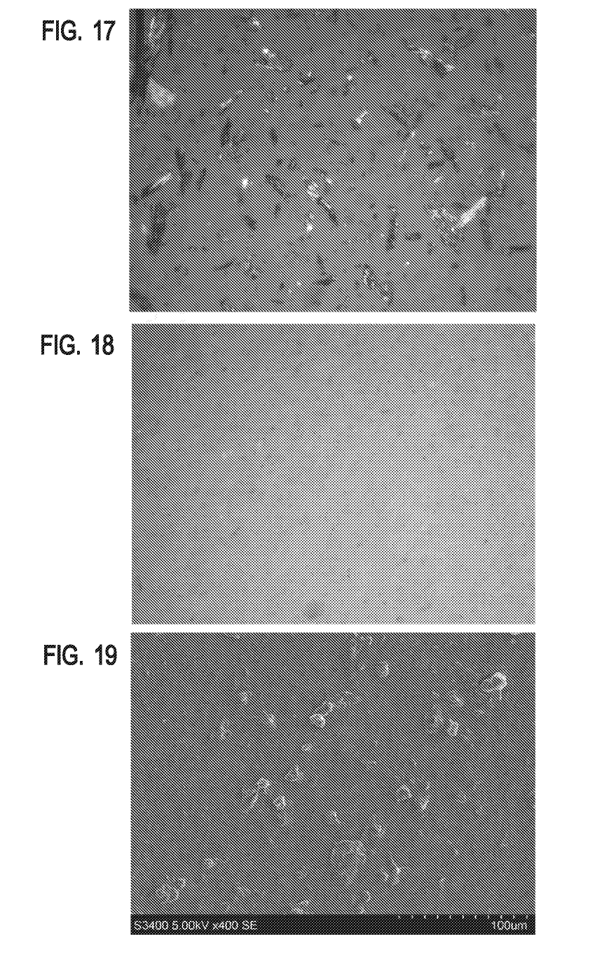

A liquid spray composition of 1:0.077 paliperidone palmitate:Tween 20 in 50:50 (v:v) methanol:toluene and 0.1 mg/mL ammonium acetate was prepared and sprayed for five minutes onto a stainless steel plate, which was at a temperature of approximately 70° C., using Electrospray System Parameters A with the exception that the main voltage was 29.5 kV and the extractor voltage was 18.8 kV. The results are shown in the 40× and 10× microscope images of FIGS. 17 and 18, respectively, and the 100 μm scale scanning electron image of FIG. 19.

### Example 6

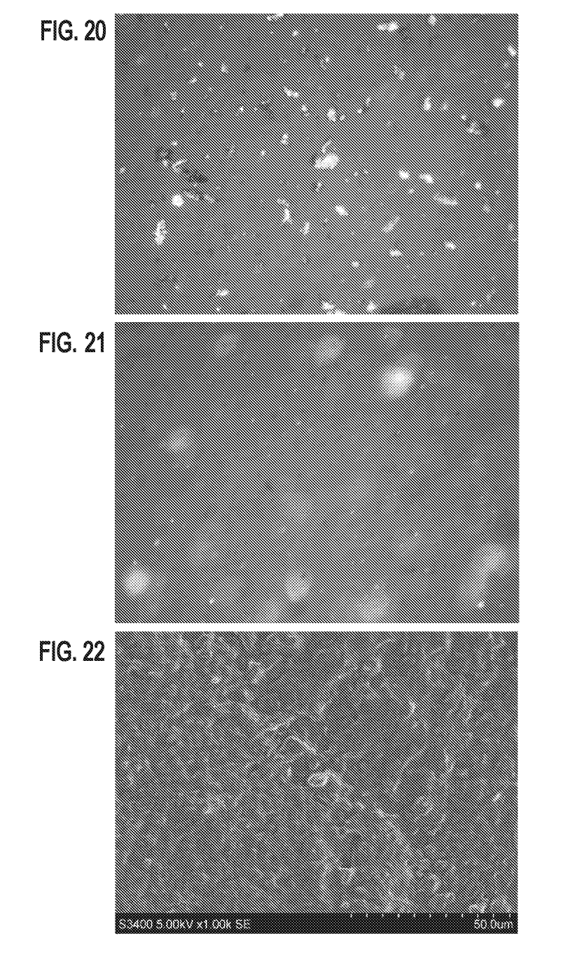

A liquid spray composition of 1:0.19:0.077 paliperidone palmitate:polyethylene glycol:Tween 20 in 50:50 (v:v) methanol:toluene was prepared and sprayed for five minutes onto a stainless steel plate, which was at a temperature of approximately 70° C., using Electrospray System Parameters A with the exception that the main voltage was 29.5 kV and the extractor voltage was 18.8 kV. The results are shown in the 40× and 10× microscope images of FIGS. 20 and 21, respectively, and the 50 μm scale scanning electron image of FIG. 22.

### Example 7

The liquid spray composition of 1% by weight paliperidone palmitate in 5:95 (v:v) water:tetrahydrofuran is sprayed onto a stainless steel coupon followed by a spray of 4:6 (v:v) methanol:water and 0.03% Tween 20. Paliperidone palmitate particles are expected to be obtained.

### Example 8

The liquid spray composition of Example 1 is sprayed into a 4:6 (v:v) methanol:water and 0.03% Tween 20 composition. Paliperidone palmitate particles are expected to be captured in the liquid composition, the composition is dried, and paliperidone palmitate particles are expected to be obtained.

### Example 9

An aluminum substrate was abraded with a 150 grit sandpaper to increase the surface area thereof. The abraded surface is then positioned on the collector plate and the liquid spray composition of Example 1 was sprayed onto the abraded surface using the electrospray system parameters set forth above.

### Example 10

An aluminum substrate was abraded with a 600 grit sandpaper to increase the surface area thereof. The abraded surface was then positioned on the collector plate and the liquid spray composition of Example 1 was sprayed onto the abraded surface using the electrospray system parameters set forth above.

### Example 11

An aluminum substrate was abraded as described in Example 9, placed on a stage that had been heated to a temperature of 70° C., and then sprayed as described in Example 9.

### Example 12

The liquid spray composition of Example 1 is sprayed into a liquid collector composition identified in Table 3 below, which has been heated to the temperature indicated in Table 3.

TABLE 3

| | | | | Water and |
|---|---|---|---|---|
| | | Water and | Water and | Methanol |
| | | 0.03% | Methanol | (40:60) and |
| Temperature | Water | Tween 20 | (40:60) | Tween 20 |
| 45° C. | X | X | NT | NT |
| 55° C. | X | X | NT | NT |
| 65° C. | X | X | NT | NT |

NT = Not Tested

### Example 13

A liquid spray solution of 1% by weight paliperidone palmitate, 0.19% by weight PEG 4000, and 0.077% by weight Tween 20 in 50:50 methanol:toluene was sprayed into a liquid collector composition identified in Table 4 below, which had been cooled to the temperatures indicated in Table 4.

TABLE 4

| | | Water and | |
|---|---|---|---|
| | | Methanol | Water and |
| | Water and | (40:60) and | Methanol |
| | Methanol | 0.03% | (35:65) and |
| Temperature | (40:60) | Tween 20 | Tween 20 |
| 6° C. | NT | X | NT |
| −40° C. | X | X | NT |
| −65° C. | NT | NT | X |

### Example 14

A solution of 1% by weight paliperidone palmitate, 0.19% by weight PEG 4000, and 0.077% by weight Tween 20 in 50:50 methanol:toluene was sprayed onto dry ice.

### Example 15

A solution of 1% by weight paliperidone palmitate, 0.19% by weight PEG 4000, and 0.077% by weight Tween 20 in 50:50 methanol:toluene was sprayed into liquid nitrogen.

### Example 16

An electrically conductive plate is cooled to 0° C. and then placed at the collector of the electrospray system set forth above. The liquid spray composition of Example 1 is sprayed onto the chilled plate and particles are collected.

The particles are separated from one another, heated to a temperature less than the melting point of the paliperidone palmitate, and then cooled to achieve discrete, crystalline particles.

### Example 17

An electrically conductive plate is chilled by placing the plate in dry ice until the plate reached a temperature of approximately −65° C. The chilled plate is then placed at the collector of the electrospray system set forth above. The liquid spray composition of Example 1 is sprayed onto the chilled plate and particles are collected. The particles are then placed in a slurry of hexane and water, the hexane is removed, and any residual hexane is evaporated leaving particles.

The particles are separated from one another, heated to a temperature less than the melting point of the paliperidone palmitate, and then cooled to achieve discrete, crystalline particles.

### Example 18

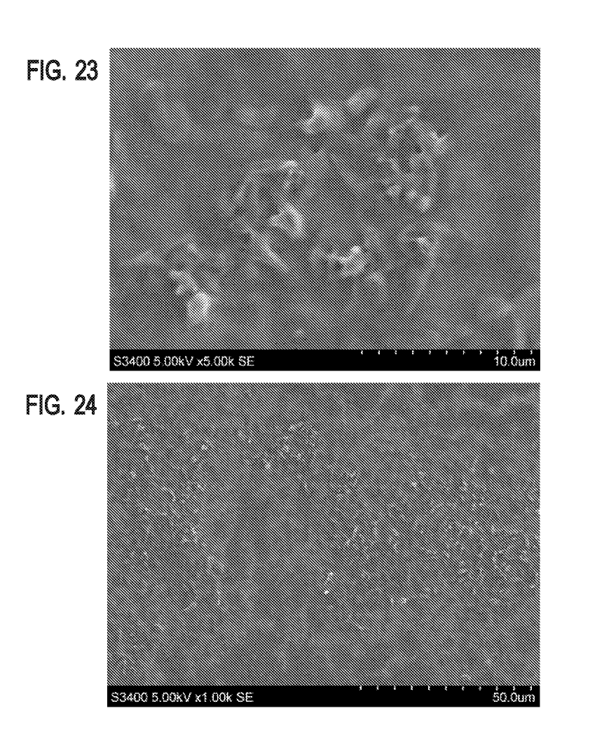

A stainless steel coupon was placed on a heated collector that had been heated to a temperature of 70° C. just prior to contact with the coupon. A liquid spray composition of 1% paliperidone palmitate in a 50:50 (v:v) solution of methanol and tetrahydrofuran was sprayed onto the stainless steel coupon using the electrospray system set forth above. The results are shown in the 10 μm and 50 μm scale scanning electron images of FIGS. 23 and 24, respectively.

### Example 19

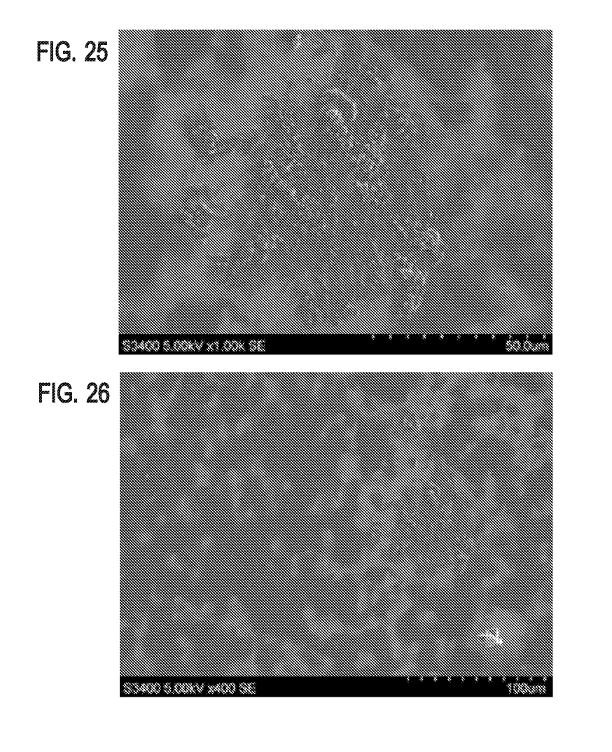

A stainless steel coupon was coated as described in Example 18 with the exception that the collector had been heated to a temperature of 80° C. just prior to contact with the coupon. The results of Examples 19 are shown in the 50 μm and 100 μm scale scanning electron images of FIGS. 25 and 26, respectively.

### Example 20

A series of liquid spray compositions of the compositions indicated in Table 5 below were sprayed onto stainless steel plates that had been heated to 70° C. and 80° C.

TABLE 5

| PPD | | | | |
|---|---|---|---|---|
| (% by | Tween 20 | PEG 4000 | NH₄ Acetate | |
| weight) | (% by weight) | (% by weight) | (mg/ml) | MeOH:Toluene |
| 1 | 0 | 0 | 0 | 50:50 |
| 1 | 0 | 0 | 0 | 70:30 |
| 1 | 0 | 0 | 0.04 | 50:50 |
| 1 | 0 | 0 | 0.04 | 70:30 |
| 1 | 0 | 0 | 0.1 | 50:50 |
| 1 | 0 | 0 | 0.1 | 70:30 |
| 1 | 0 | 0.25 | 0 | 50:50 |
| 1 | 0 | 0.25 | 0 | 70:30 |
| 1 | 0 | 0.25 | 0.04 | 50:50 |
| 1 | 0 | 0.25 | 0.04 | 70:30 |
| 1 | 0 | 0.19 | 0.04 | 50:50 |
| 1 | 0 | 0.19 | 0.04 | 70:30 |
| 1 | 0 | 0.25 | 0.1 | 50:50 |
| 1 | 0 | 0.25 | 0.1 | 70:30 |
| 1 | 0 | 0.19 | 0.1 | 50:50 |
| 1 | 0 | 0.19 | 0.1 | 70:30 |
| 1 | 0.033 | 0 | 0 | 50:50 |
| 1 | 0.033 | 0 | 0 | 70:30 |
| 1 | 0.033 | 0 | 0.04 | 50:50 |
| 1 | 0.033 | 0 | 0.04 | 70:30 |
| 1 | 0.033 | 0 | 0.1 | 50:50 |
| 1 | 0.033 | 0 | 0.1 | 70:30 |
| 1 | 0.077 | 0 | 0 | 50:50 |
| 1 | 0.077 | 0 | 0.0 | 70:30 |
| 1 | 0.077 | 0 | 0.04 | 50:50 |
| 1 | 0.077 | 0 | 0.04 | 70:30 |
| 1 | 0.077 | 0 | 0.1 | 50:50 |
| 1 | 0.077 | 0 | 0.1 | 70:30 |

PPD = paliperidone palmitate
NH₄ Acetate = ammonium acetate
MeOH = methanol

### Example 21

A series of liquid spray compositions that included each combination of the following components were prepared: 1% by weight paliperidone palmitate, 0.033% by weight or 0.077% by weight Tween 20, 0.25% by weight or 0.19% by weight PEG 4000, and 0 mg/ml, 0.04 mg/ml, or 0.1 mg/ml ammonium acetate in a 50:50 or 70:30 methanol:toluene solution were prepared and sprayed onto stainless steel plates that had been heated to 70° C. and 80° C.

### Examples 22a-c

A liquid spray composition that included 1% by weight indomethacin in a 50:50 v/v ethanol:acetone solution was prepared and sprayed at room temperature onto a stainless steel plate (Example 22a). The same composition was sprayed onto an aluminum block that had been heated to 138° C. and was 88° C. when spraying was stopped (Example 22b). The same composition also was sprayed onto an aluminum block that had been heated to 68° C. and was 54° C. when spraying was stopped (Example 22c).

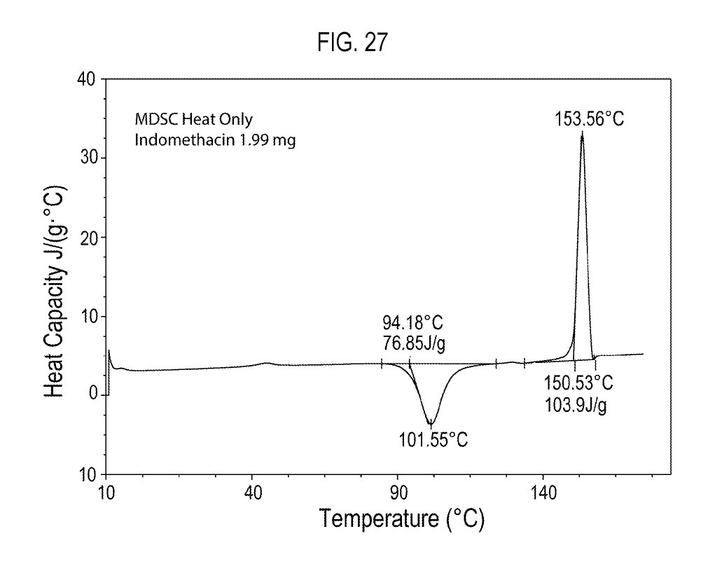

The liquid spray composition of Example 22a was analyzed using DSC and was determined to have a Tg of approximately 45° C. and recrystallization endotherm from approximately 85° C. to 124° C. The modulated DSC thermogram (heat cycle only) is shown in FIG. 27.

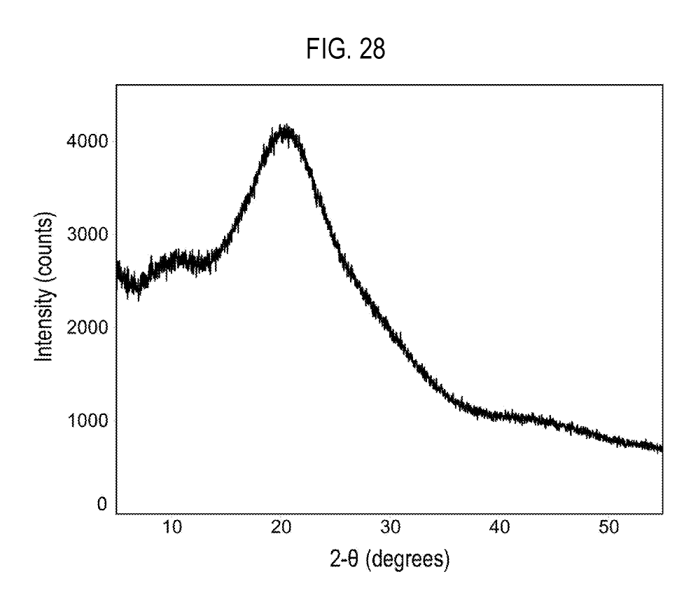

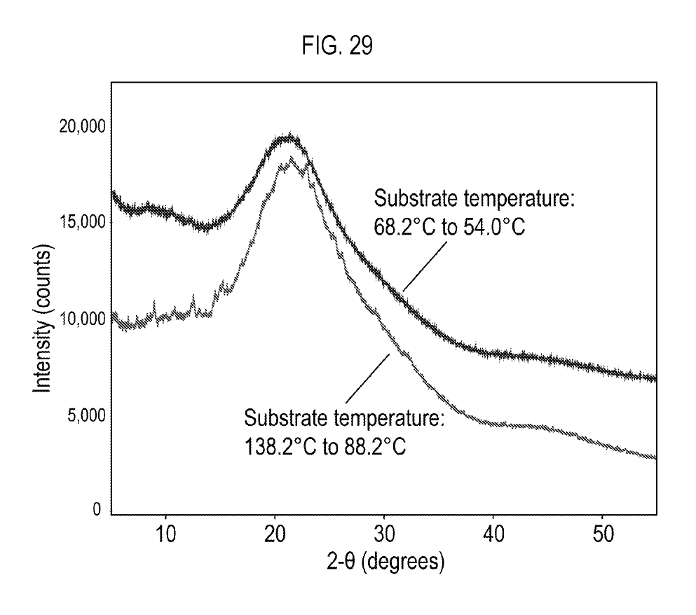

The X-ray diffraction profile of the product Example 22c shows an amorphous halo, as shown in FIG. 28 and the upper plot in FIG. 29. The X-ray diffraction profile of the product of Example 22b shows crystalline peaks on the amorphous halo, as shown by the lower plot in FIG. 29.

### Example 23

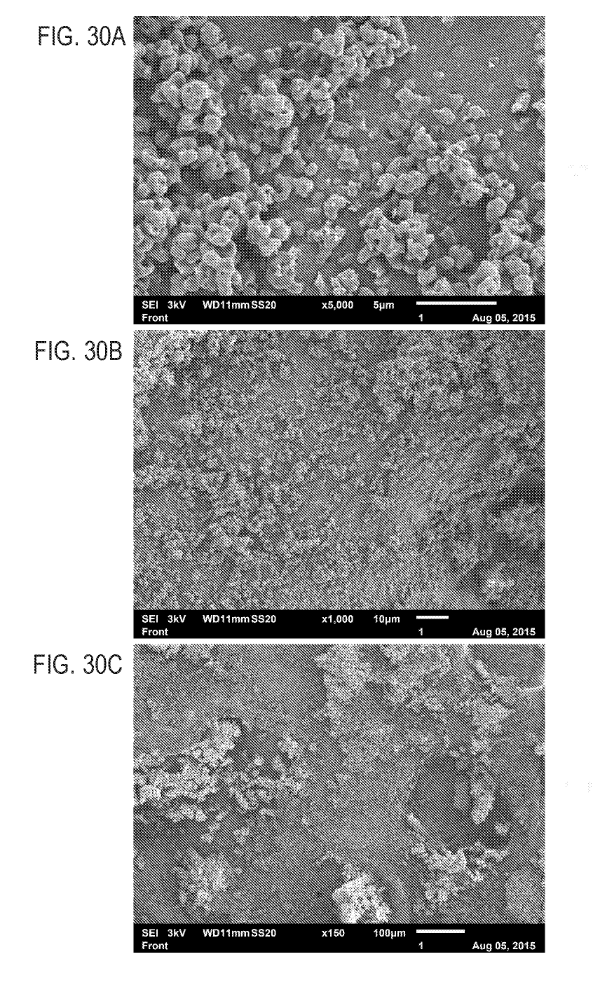

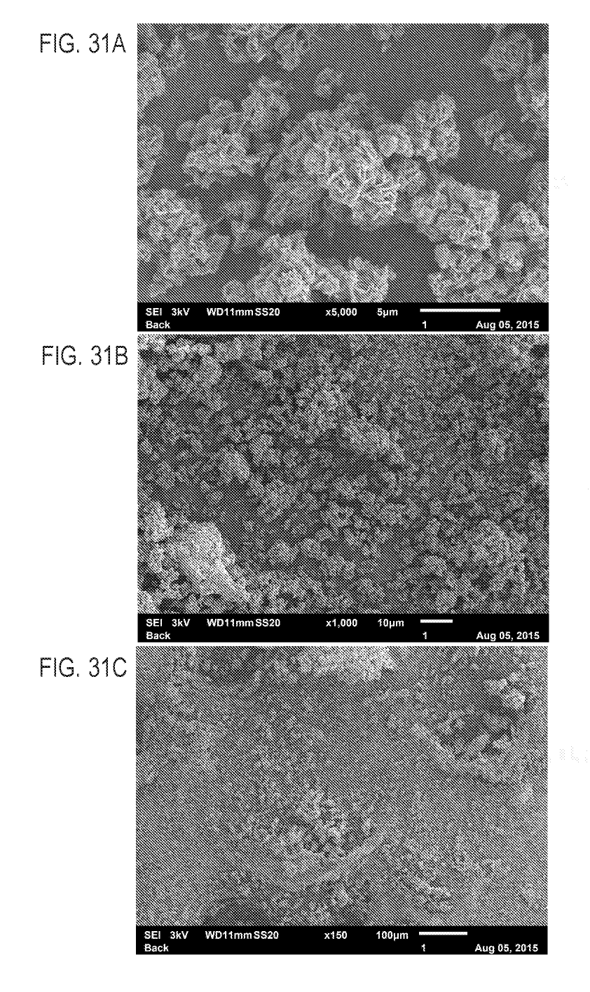

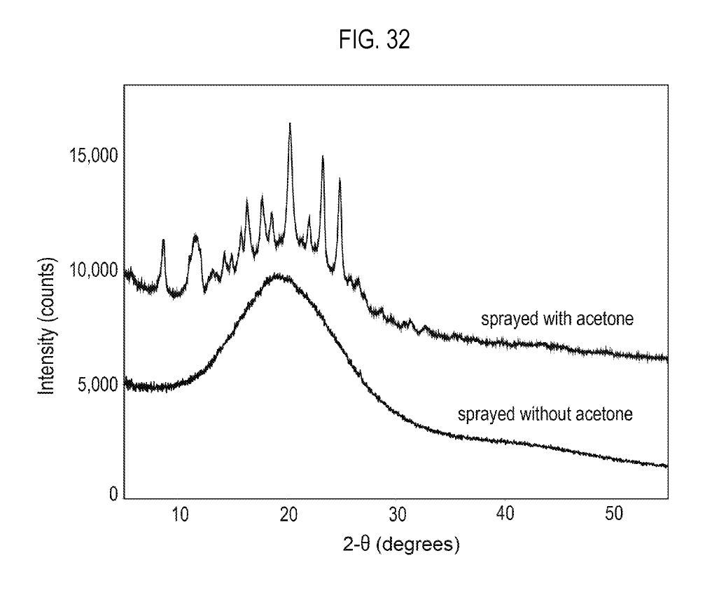

A liquid spray composition, which included aripiprazole dissolved in a carrier of 30% Methanol, 68% dichloromethane and 2% water, was sprayed from an electrospray system that included a plurality of nozzles and a collector plate that was positioned on a moving stage. First the liquid spray composition was sprayed onto the collector as the collector passed under the liquid spray composition. Then, acetone was sprayed from a second set of nozzles as the collector passed under the spray of acetone. This process was repeated multiple times over a period of 30 minutes. A powder resulted from the spray process. The dry powder was collected and analyzed by SEM and XRD and the results are shown in the SEM images of FIGS. 30A-C and 31A-C and the plot of FIG. 31. SEM images of the powder that was sprayed with acetone at 5 μm, 10 μm, and 100 μm scales are shown in FIGS. 30A-30C, respectively. SEM images of the powder that was not sprayed with acetone are shown at 5 μm, 10 μm, and 100 μm scales are shown in FIGS. 31A-31C, respectively. In FIG. 32, the upper XRD profile is of powder that was sprayed with acetone, and the lower XRD profile is of powder that was not sprayed with acetone.

Other embodiments are within the claims. For example, although a method of electrospraying that includes neutralizing the charge on charged particles to form neutralized particles has described above as including a step of heating the neutralized particles, the method can be conducted in the absence of a heating step. One example of such a method includes spraying a liquid spray composition that includes a compound from a nozzle to form charged particles of the compound, neutralizing the charge on the particles to form neutralized particles, and collecting the neutralized particles.

In another embodiment, the method of electrospraying includes spraying a first liquid spray composition on the collector and subsequently spraying a second liquid spray composition different from the first liquid spray composition toward the collector, where one of the first liquid spray composition and the second liquid spray composition includes a volatile organic solvent and is free of a compound of interest and the other of the first liquid spray composition and the second liquid spray composition includes a carrier and the compound of interest. In one embodiment, the first liquid spray composition is a volatile organic solvent, and the second liquid spray composition includes the compound of interest and a liquid carrier. In another embodiment, the first liquid spray composition includes the compound of interest and a liquid carrier and spraying the first liquid spray composition deposits particles of the compound on the collector, and the second liquid spray composition includes a volatile organic solvent. The method optionally further includes drying the surface of the collector after at least one of the spraying operations, repeating at least one of the spraying, repeating a drying step, and combinations thereof. Any number of different or identical liquid spray compositions can be sprayed in the method. The spray compositions can be applied sequentially, simultaneously, and in combinations thereof. In some embodiments, the compound of interest is not soluble in the liquid of the spray composition that is free of the compound of interest. The temperature of the multiple spray streams can be altered (e.g., heated, cooled, and combinations thereof) as described above and can be combined with temperature altered (i.e., heated or cooled) collectors, nozzles, gas streams, and combinations thereof. The sprays can be sprayed on any suitable collector including, e.g., liquid collectors, solid collectors (e.g., collector plates and coupons), dynamic collectors, variable topography collectors, and combinations thereof), and combinations thereof.

In another embodiment, the method of electrospraying includes spraying a liquid spray composition on a surface of a collector that includes an initial crystalline layer (i.e., an initial crystal nucleating layer). The initial crystalline layer can be continuous or discontinuous and can have any suitable thickness including, e.g., a thickness of no greater than 10 μm or even less than 5 μm. The liquid spray composition includes a compound of interest, and the initial crystalline layer preferably is selected to be of such a nature so as to facilitate the formation of crystals of the compound of interest (i.e., the initial crystalline layer can nucleate the formation of crystals of the compound of interest). The crystals can form on the surface of the collector as the liquid spray composition is sprayed onto the collector, subsequent to the spraying operation (e.g., during storage), and combinations thereof. The method optionally further includes storing the sprayed collector for a period of time and under environmental conditions that further facilitate formation of crystals of the sprayed compound of interest. The method optionally further includes applying the initial crystal nucleating layer on the surface of the collector.

In another embodiment, the method of electrospraying includes electrospraying a liquid spray composition from a nozzle onto a nanoscale variable topography collector, one example of which is a metal plate that has been abraded with a fine grit sandpaper having any suitable grit including, e.g., no greater than about 100 grit, no greater than about 150 grit or even no greater than about 600 grit.

1. A method of electrospraying particles, the method comprising electrospraying a liquid spray composition from a nozzle, the liquid spray composition comprising a liquid and a compound exhibiting a melting point and a crystallization temperature, and collecting particles formed from the liquid spray composition on a collector having a temperature that is from at least the crystallization temperature of the compound to a temperature that is less than the melting point of the compound.

2. A method of electrospraying particles, the method comprising electrospraying a first liquid composition from a nozzle into a second liquid composition, the first liquid composition comprising an organic solvent and a compound, and the second liquid composition comprising an organic solvent that is in a liquid state at ambient conditions.

3. A method of electrospraying particles, the method comprising electrospraying a first liquid spray composition from a nozzle onto a collector, the liquid spray composition comprising a liquid and a compound, collecting particles formed from the liquid spray composition on the collector, electrospraying a second liquid spray composition on the collected particles, the second liquid spray composition comprising a volatile organic solvent, and subsequently electrospraying the first liquid spray composition from a nozzle onto the collected particles.

4. A method of electrospraying particles, the method comprising electrospraying a first liquid spray composition from a nozzle from a nozzle onto dry ice.

5. A method of electrospraying particles, the method comprising electrospraying a liquid spray composition from a nozzle, the liquid spray composition comprising a liquid and a compound, forming charged particles, neutralizing the charge on the charged particles to form neutralized particles, passing the neutralized particles through heated environment, and collecting the neutralized particles.

6. A method of decreasing the particle size of a compound having a Tg no greater than room temperature, the method comprising forming a liquid composition from a liquid and a compound having a Tg no greater than room temperature, a crystallization temperature, and a melting point, the compound exhibiting a first particle size, electrospraying the liquid composition from a nozzle of an electrospray system, heating the compound to a temperature that is from the crystallization temperature of the compound to less than the melting point of the compound, and collecting particles formed from the liquid composition, the collected particles exhibiting a second particle size that is less than the first particle size.

7. A method of electrospraying particles, the method comprising electrospraying a volatile organic solvent from a nozzle onto a collector, and subsequently electrospraying a stream of particles from a nozzle onto the collector.

8. The method of any one of paragraphs 1-7, wherein, prior to the electrospraying, the collector comprises a surface having a variable topography on a nanometer scale.

9. The method of any one of paragraphs 1-8, wherein, prior to the electrospraying, nanoparticles are present on the collector.

10. The method of any one of paragraphs 1-9, wherein, prior to electrospraying, the collector comprises a layer having a thickness of less than 5 μm and comprising the compound in crystalline form.

11. The method of any one of paragraphs 1-10, wherein the compound has a Tg no greater than room temperature

12. The method of any one of paragraphs 1-11, wherein the collected particles comprise discrete particles.

13. The method of any one of paragraphs 1-12, wherein the collected particles comprise the compound in crystalline form.

14. The method of any one of paragraphs 1-13, wherein the collected particles comprise discrete particles of the compound in crystalline form.

15. The method of any one of paragraphs 1-14 further comprising spraying the collected particles to with organic solvent.

16. The method of any one of paragraphs 1-15 further comprising spraying the collected particles to organic solvent vapors for a period of time sufficient to form crystals of the compound.

17. The method of any one of paragraphs 3 and 8-16, wherein the second liquid composition comprises a first organic solvent and a second organic solvent different from the first organic solvent.

18. The method of paragraph any one of paragraphs 3 and 8-17, wherein the second liquid composition further comprises water.

19. The method of any one of paragraphs 3 and 8-18, wherein the second liquid composition further comprises a surfactant.

20. The method of any one of paragraphs 3 and 8-19, wherein the second liquid composition further comprises dry ice.

21. The method of any one of paragraphs 3 and 8-20, wherein the particles are insoluble in the second liquid composition.

22. The method of any one of paragraphs 3 and 8-21, wherein the second liquid composition is at a temperature of at least one of greater than 30° C., no greater than 15° C., no greater than 0° C., and no greater than −20° C.

23. The method of any one of paragraphs 3 and 8-22, wherein the first liquid composition comprises a polar organic solvent and the second liquid composition comprises a nonpolar organic solvent.

24. The method of any one of paragraphs 3 and 8-23, wherein the first liquid composition is polar and the second liquid composition is nonpolar.

25. The method of any one of paragraphs 3 and 8-24, wherein the particles are insoluble in the second liquid spray composition.

26 The method of any one of paragraphs 5 and 8-25 further comprising maintaining the heated environment at a temperature that is from at least the crystallization temperature of the compound to a temperature that is less than the melting point of the compound.

27. The method of any one of paragraphs 5 and 8-26 further comprising cooling the particles.

28. The method of any one of paragraphs 5 and 8-27, wherein the compound exhibits a melting point and a crystallization temperature.

29. The method of any one of paragraphs 5 and 8-28, wherein the heated environment is at a temperature from greater than the crystallization temperature of the compound to a temperature that is less than the melting point of the compound.

30. An electrospray system comprising a source to provide a liquid composition, a nozzle apparatus configured to receive and electrospray the liquid composition when the system is in operation, a charge neutralizer configured to receive the electrosprayed liquid composition and provide a neutralized electrospray when the system is in operation, a temperature modification apparatus to provide a temperature modified environment through which the neutralized electrospray passes when the system is in operation resulting in a temperature modified electrospray, and a collector to collect the temperature modified electrospray.

31. The system of claim 29, wherein the temperature modification apparatus comprises a heated environment

32. The system of claim 29, wherein the temperature modification apparatus comprises a tube furnace.

What is claimed is:

1. A method of electrospraying particles, the method comprising:
electrospraying a liquid spray composition from a nozzle, the liquid spray composition comprising a liquid and a compound exhibiting a melting point and a crystallization temperature; and
collecting particles formed from the liquid spray composition on a collector having a temperature that is from at least the crystallization temperature of the compound to a temperature that is less than the melting point of the compound.

2. The method of claim 1, wherein, prior to the electrospraying, the collector comprises a surface having a variable topography on a nanometer scale.

3. The method of claim 1, wherein, prior to the electrospraying, nanoparticles are present on the collector.

4. The method of claim 1, wherein, prior to electrospraying, the collector comprises a layer having a thickness of less than 5 μm and comprising the compound in crystalline form.

5. The method of claim 1, wherein the compound has a Tg no greater than room temperature

6. The method of claim 1, wherein the collected particles comprise discrete particles.

7. The method of claim 1, wherein the collected particles comprise the compound in crystalline form.

8. The method of claim 1, wherein the collected particles comprise discrete particles of the compound in crystalline form.

9. The method of claim 1 further comprising spraying the collected particles to with organic solvent.

10. The method of claim 1 further comprising spraying the collected particles to organic solvent vapors for a period of time sufficient to form crystals of the compound.

11. A method of electrospraying particles, the method comprising:
electrospraying a first liquid composition from a nozzle into a second liquid composition, the first liquid composition comprising an organic solvent and a compound, and the second liquid composition comprising an organic solvent that is in a liquid state at ambient conditions.

12. The method of claim 11, wherein the second liquid composition comprises a first organic solvent and a second organic solvent different from the first organic solvent.

13. The method of claim 11, wherein the second liquid composition further comprises water.

14. The method of claim 12, wherein the second liquid composition further comprises a surfactant.

15. The method of claim 11, wherein the second liquid composition further comprises dry ice.

16. The method of claim 11, wherein the particles are insoluble in the second liquid composition.

17. The method of claim 11, wherein the second liquid composition is at a temperature of no greater than 15° C.

18. The method of claim 11, wherein the first liquid composition comprises a polar organic solvent and the second liquid composition comprises a nonpolar organic solvent.

19. The method of claim 11, wherein the first liquid composition is polar and the second liquid composition is nonpolar.

20. A method of electrospraying particles, the method comprising:
electrospraying a first liquid spray composition from a nozzle onto a collector, the liquid spray composition comprising a liquid and a compound;
collecting particles formed from the liquid spray composition on the collector;
electrospraying a second liquid spray composition on the collected particles, the second liquid spray composition comprising a volatile organic solvent; and
subsequently electrospraying the first liquid spray composition from a nozzle onto the collected particles.

21. The method of claim 20, wherein the particles are insoluble in the second liquid spray composition.
